(19) United States
(12) Patent Application Publication
(10) Pub. No.: US 2013/0324388 A1
(43) Pub. Date: Dec. 5, 2013

(54) METHOD AND DEVICE FOR SEPARATING AND TRANSFERRING CONTAINER CONTENTS BY DYNAMICAL USE OF CENTRIFUGE FORCE

(71) Applicant: Pedro Ernesto Goncalves Guedes, Porto (PT)

(72) Inventor: Pedro Ernesto Goncalves Guedes, Porto (PT)

(73) Assignee: ISENS - ELECTRONICA, LDA., Porto (PT)

(21) Appl. No.: 13/992,185

(22) PCT Filed: Dec. 9, 2010
(86) PCT No.: PCT/PT10/00056

§ 371 Date: Aug. 15, 2013

(51) Int. Cl. B04B 5/02

(52) U.S. Cl. CPC B04B 5/02
USPC 494/16; 494/43; 494/37

(57) ABSTRACT

The present invention relates to a method and device for separating and transferring container (1) contents by dynamical use of centrifuge force, transferring a specific volume of liquid (A) from a recipient (1) to another (2) without contact with any external element other than the initial container (1) itself. Therefore, the present invention is useful for transferring for example part of a blood sample (A) from a tube (1) without touching the blood sample, also dispensing with a disposable needle as is currently usual. The invention is also advantageous as it allows keeping in the original container (1) a predetermined portion of the sample (B). By rotating the container, with a sufficiently high speed, over an axis (x) located at the boundary of the parts (A, B), the sample is split at a predetermined position. A preferred embodiment comprises the container at an angle (V) to the rotation axis (x).

### TECHNICAL FIELD OF THE INVENTION

The present invention relates to a method and device for separating and transferring container contents by dynamical use of centrifuge force, in particular laboratory samples, namely contained in laboratory tubes.

### GENERAL DESCRIPTION OF THE INVENTION

The present invent-ion relates to a method and device for separating and transferring container (1) contents by dynamical use of centrifuge force, transferring a specific volume of liquid (A) from a recipient (1) to another (2) without contact with any external element other than the initial container (1) itself.

Therefore, the present invention is useful for transferring for example part of a blood sample (A) from a tube (1) without touching the blood sample, also dispensing with a disposable needle as is currently usual.

The invention is also advantageous as it allows keeping in the original container (1) a predetermined portion of the sample (B).

In a preferred embodiment, by rotating the container, with a sufficiently high speed, over an axis (X) located at the boundary of the parts (A, B), the sample is split at the predetermined position.

A further preferred embodiment comprises the container (1) being place with its opening part axis at an angle (V) to the rotation axis (x).

A further preferred embodiment comprises the container (1) opening axis perpendicular to the rotation axis (x).

In another preferred embodiment, by rotating the container, with a predetermined speed, over an axis (X), located not necessarily at the boundary of the parts (A, B), the sample is split at a predetermined position.

### DESCRIPTION OF THE DRAWINGS

FIG. 1: Schematic representation of sample (A+B) in a container or tube (1).

FIG. 2: Schematic representation of sample (A) separated from the remaining contents (B).

FIG. 3: Schematic representation of a rotation axis (x) located at the sample separation boundary.

FIG. 4: Schematic representation of centrifugal force (F) separating A and B away from the rotation axis (x).

FIG. 5: Schematic representation of tube being rotated along an axis (x).

FIG. 6: Schematic representation of tube being rotated along an axis (x) together with a secondary tube (2) for collecting the separated sample (A).

FIG. 7: Schematic representation of the sequence of rotation of the sample tube around an axis (x) together with a secondary tube (2) which collects the separated sample (B).

FIG. 8: Schematic representation of a first preferred embodiment when static.

FIG. 9: Schematic representation of a first preferred embodiment when in motion.

FIG. 10: Schematic representation of a second preferred embodiment when static.

FIG. 11: Schematic representation of a second preferred embodiment when in motion.

FIG. 12: Schematic representation of a third preferred embodiment when static.

FIG. 13: Schematic representation of a fourth preferred embodiment when in the initial position.

FIG. 14: Schematic representation of a fourth preferred embodiment when in the final position.

FIG. 15: Schematic representation of a fifth preferred embodiment when static.

FIG. 16: Schematic representation of a blood sample tube with a separation gel.

FIG. 17: Schematic representation of an embodiment without Coriolis force compensation.

FIG. 18: Schematic representation of an embodiment with Coriolis force compensation.

FIG. 19: Schematic representation of a first preferred embodiment of an automated laboratory system with the previous sample separator.

FIG. 20: Schematic representation of a second preferred embodiment of an automated laboratory system with the previous sample separator.

### DETAILED DESCRIPTION OF THE INVENTION

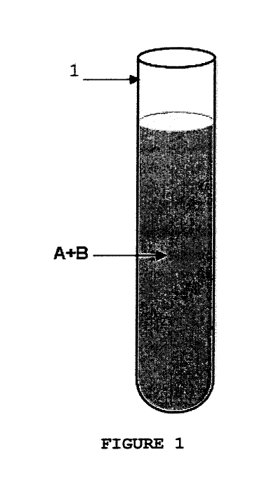

The present application has a particular application in taking blood (A+B) from a tube (1) without touching the blood namely with a disposable needle as is currently usual (FIG. 1).

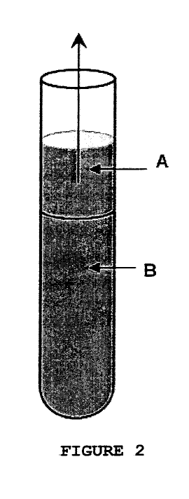

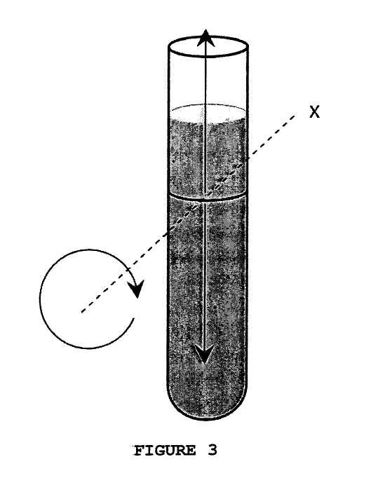

The goal is in particular to extract a certain predetermined volume of liquid (A) keeping the remaining liquid (B) inside the tube (FIG. 2). The present invention also allows for the extraction (A+B) of the full contents of the container (1).

The method here described comprises a preferred embodiment (FIG. 3) of rotating the tube (1) with sufficient speed over the axis (x) that passes substantially aligned with the liquid division, making the liquid split in opposite directions.

In this preferred embodiment the rotation speed does not need any particular accuracy because the amount of fluid that comes out of the tube is not dependent on the rotation speed, but actually on the axis position (x).

For a simple understanding of the concept, one can assume there is no gravity. The following explanations will refer for brevity sake to test tubes, but it is obvious this applies to any container containing a liquid or substantially liquidly flowing matter, even solid products, when in grain form for example.

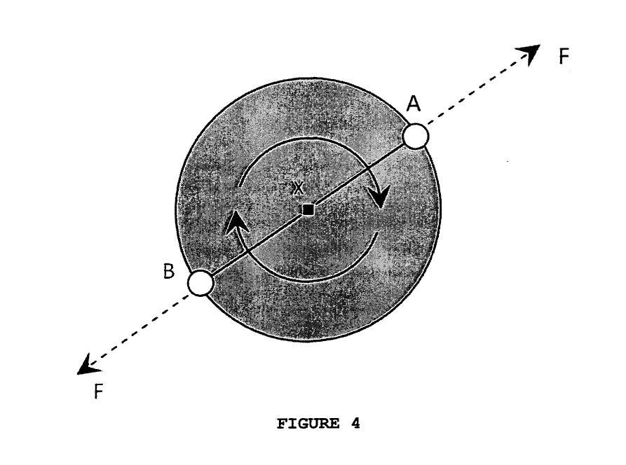

As in FIG. 4, rotating an object (A) on one axis (x) establishes a centrifugal force (F) which pushes towards the outside of the circle of rotation, perpendicular to said rotation.

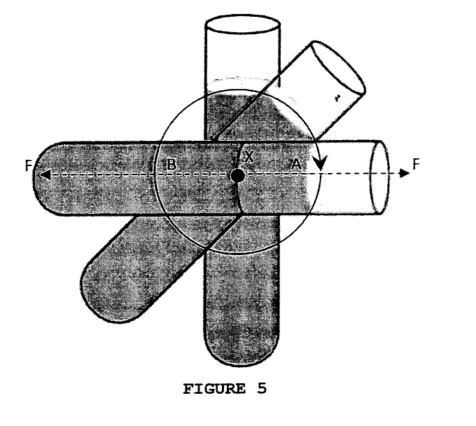

By applying the same technique to a blood tube (FIG. 5), by rotating the tube over the axis (X), the liquid portion (A) tends to go towards the outside and the: liquid portion (B) tends to stay inside the tube.

This creates the issue of capturing the liquid and transferring it into a second container, or tube, unless of course the extracted liquid (A) is to be discarded.

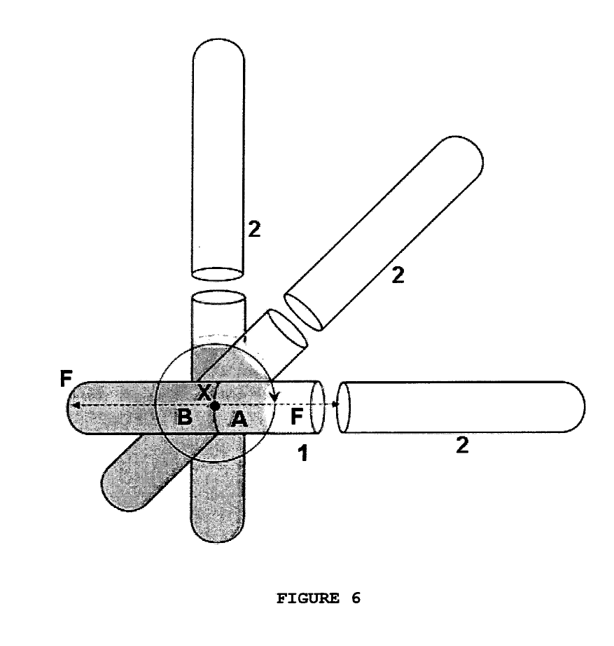

The next phase, see FIG. 6, is to add the capture of the extracted liquid and put it into a new tube (container). The solution described is to simultaneously rotate a secondary tube (2) in front of the primary tube (1).

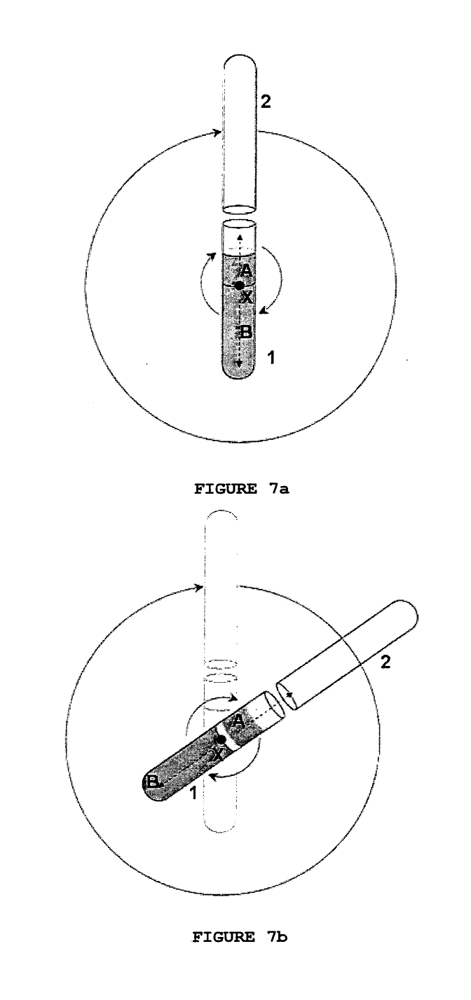

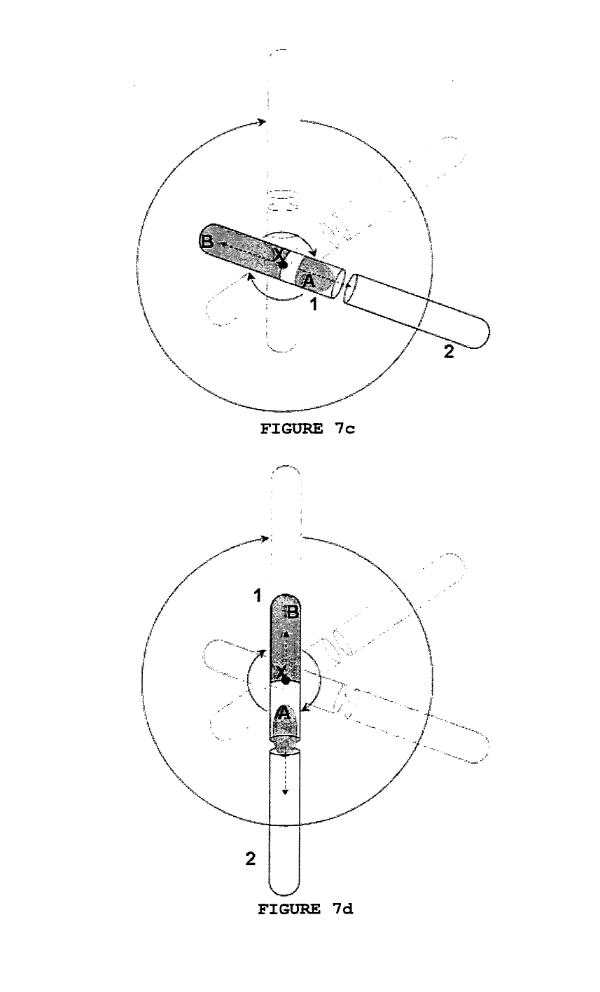

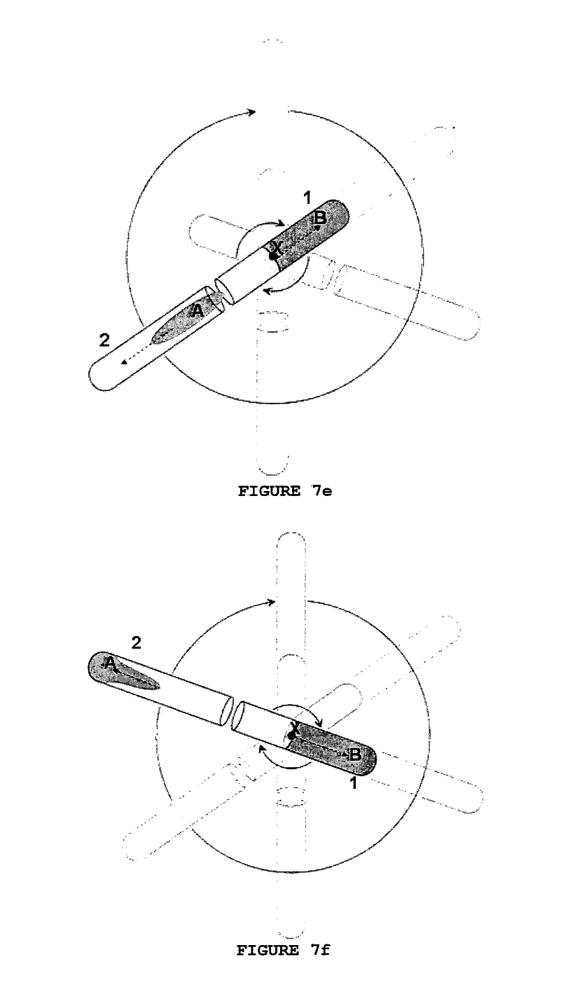

In FIG. 7, the following sequence of movement is detailed: a) the portion of the liquid to be extracted (A) and the portion of the liquid to be kept (B) are in the initial container/tube (1) which is in the initial position, together with the destination container/tube (2); b-f) the portion of the liquid to be extracted (A) is separated and transferred from tube 1 to tube 2 by the centrifugal force due to the rotation of the system; g) the portion of the liquid B does not come out of the initial tube (1) because of the centrifugal force.

In most operation situations, to be able to apply the invention, the problems caused by gravity must also be solved. The following comprises preferred embodiments of the invention, which describe different functional aspects that can be freely combined.

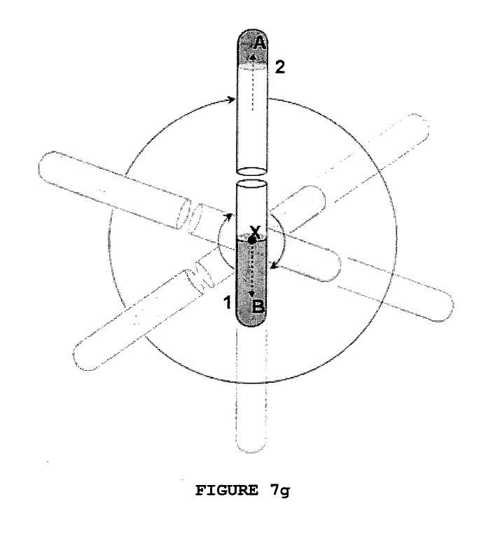

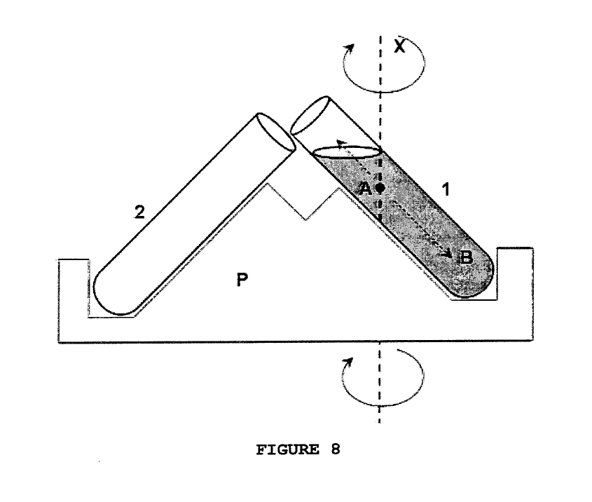

By rotating the whole system P, as in FIG. 8, on the X axis, only the liquid part ‘A’ passes from the tube 1 to tube 2, as in FIG. 9. To change the amount of liquid to be transferred, just changing the position of the axis X is required. This can be, done incrementally to extract further portions of the contents.

The V angle may be variable in that it may increase the precision and enable the rotation speed to be slower. Of course the V angle depends on the liquid volume already inside the tube 1, steep enough in order to prevent static spillage, low enough to allow easier transfers. The V angle is preferably in the range 15-70°.

In this model and most other embodiments, a speed of 150-400 RPM and 3-5 complete spins are preferable and enough to transfer 500 uL, preferably 200-800 uL.

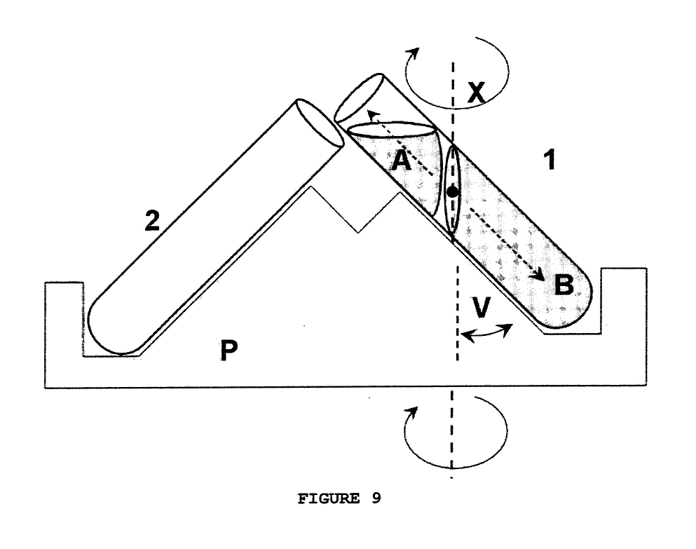

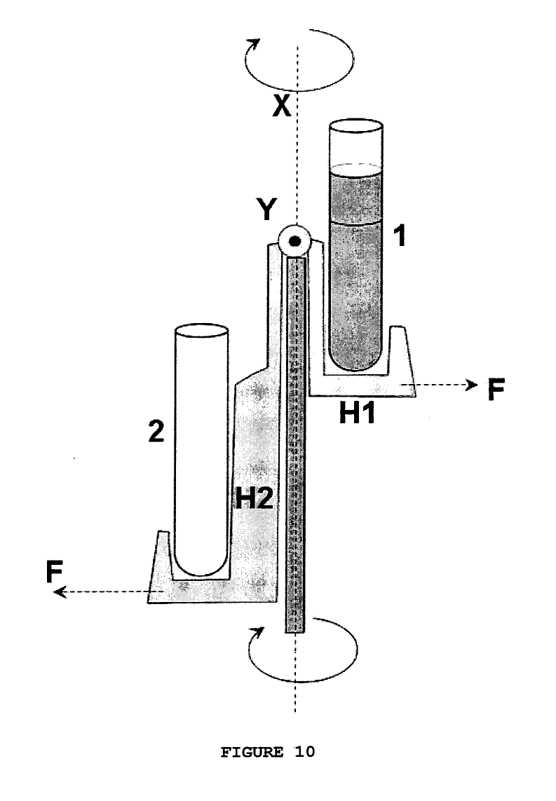

In FIG. 10, a vertical axis has a top coupling Y axially substantially perpendicular to the axis X. When the whole system rotates on the X axis, the platform H1 is driven by the centrifugal force F and rotates over the axis Y, as in FIG. 11. The same applies to the platform H2, but in the opposite direction. In this embodiment, the angle corresponding to the previous angle V is automatically adjusted by the centrifugal force itself. To regulate the amount of liquid to be transferred, the height of H1 and H2′ must be adjusted. This may be achieved by simply inserting a spacer between the tube (1): and the platform (H1). This spacer can even be electrically adjustable. This may even be unnecessary if the system is to transfer always the same predetermined quantity of contents.

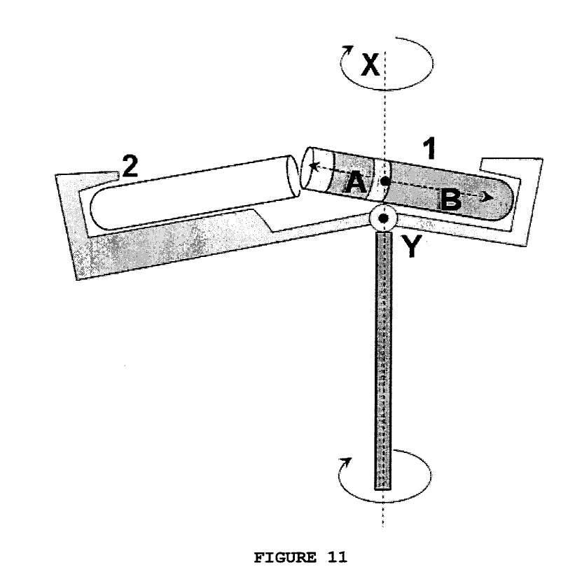

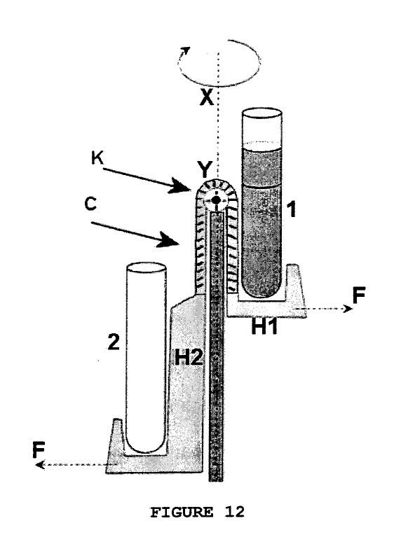

In FIG. 12, the platforms H1 and H2 can be joined together by a cable (c). The cable can be adjusted by a knob (K) to select the desired, volume to transfer. Preferably, the cable (c) connecting both platforms can be the same, rotating at a pulley (k), so that the container openings are at a substantially constant distance when in motion. The cable (c) can also be a rope, belt, or chain. A speed of 200-600 RPM is preferable.

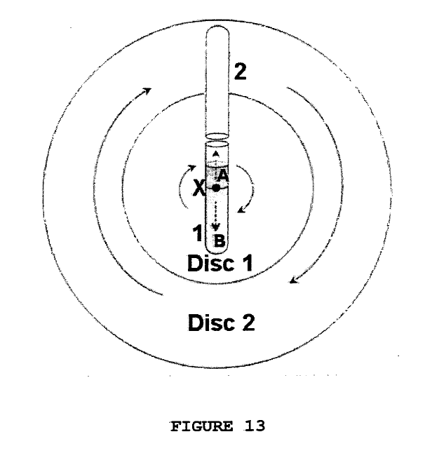

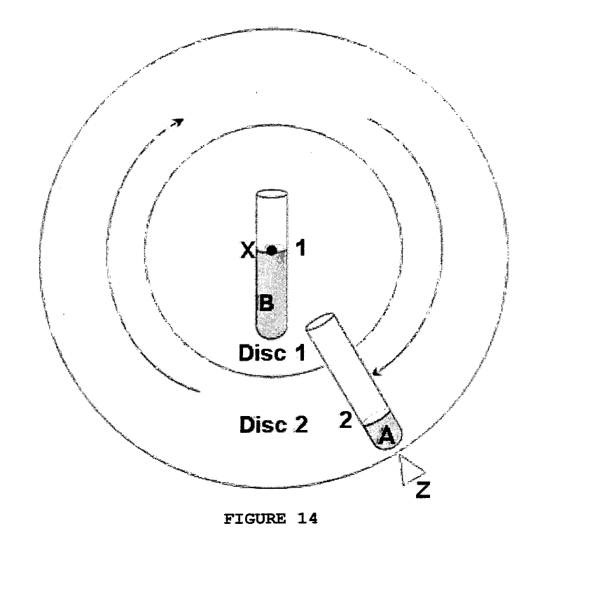

As in FIG. 13, the system can have two disks which can rotate independently. In the beginning the second tube is inverted and both discs start to rotate at the same speed. When the system rotates at high speed the force of gravity may be negligible in relation to the centrifugal force, so the previous angle V is unnecessary. In fact, this embodiment may operate, when in motion, in just about any orientation. As a consequence of the rotation around axis X, again located at the separation boundary of the contents, the liquid (A) is transferred to the destination tube (2). When the system stops rotating the initial tube (1), the second tube (2) preferably continues to rotate (FIG. 14) until the point Z is reached so that the liquid in the tube 2 does not drop from the tube. Speeds from 250-800 RPM are preferable.

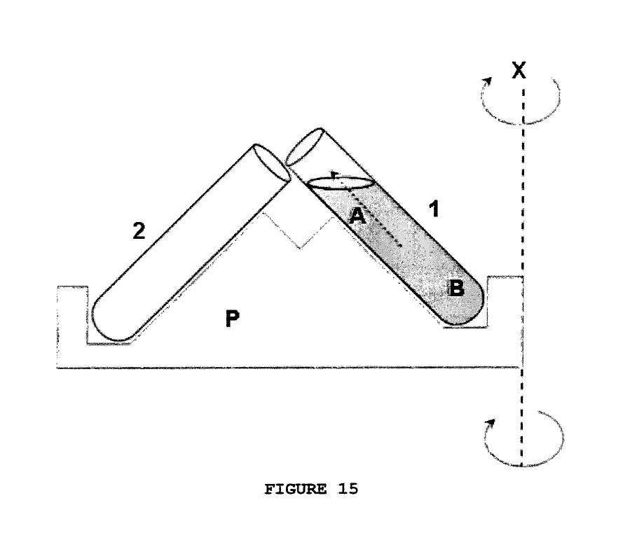

In the variant of FIG. 15, the quantity of liquid to be transferred is actually dependent of rotation speed. The X axis can be permanently fixed to a topmost position and the amount of liquid to be transferred is proportional to rotational speed. In this model, the force of gravity works against the centrifugal force and the speed is highly dependent of the rotation radius, the distance to the axis (x). Preferred values are 80-200 RPM.

The present invention is particularly suited to blood analysis, where normally the tubes are already centrifuged.

The manipulation of any other laboratory sample by this method is also advantageous as there is no contact with any other part other than the original and destination containers.

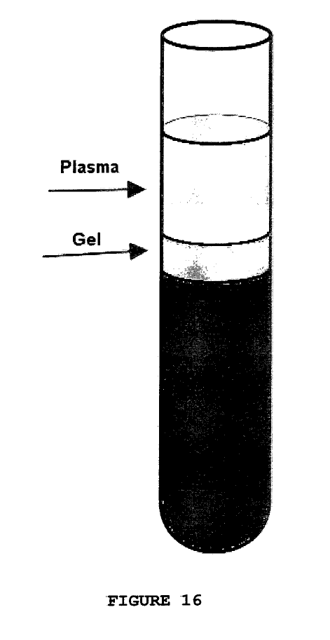

The present invention is also particularly suited to blood sample analysis when the sample includes a gel layer. Blood sample tubes usually contain a silicone gel which is used as a separator of different blood parts (FIG. 16). When centrifuged, the silicone gel forms a layer on top of the buffy coat, allowing the blood plasma to be removed more effectively for testing.

Aliquoting is usually called the action of extraction some volume from one tube to another. With traditional aliquoting systems, care must be taken to avoid the needle touching the gel region.

With the present invention's method of aliquoting, there is no problem with the separation gel, because even if the axis is somehow within the gel region, additional force must be applied to remove the gel out of the tube. So in normal conditions only the blood part above the gel region will be extracted. By spinning at a higher speed the gel layer can then be removed and discarded. By placing a third container and repeating the process, the blood part originally below the gel region can then be extracted.

In this way, a simple system could be used which simply rotates the sample as in FIG. 15, initially with a low speed suitable for extracting the topmost layer, then briefly with a high speed to extract and discard the gel layer, and finally with a speed suitable to extract the remaining lowermost layer.

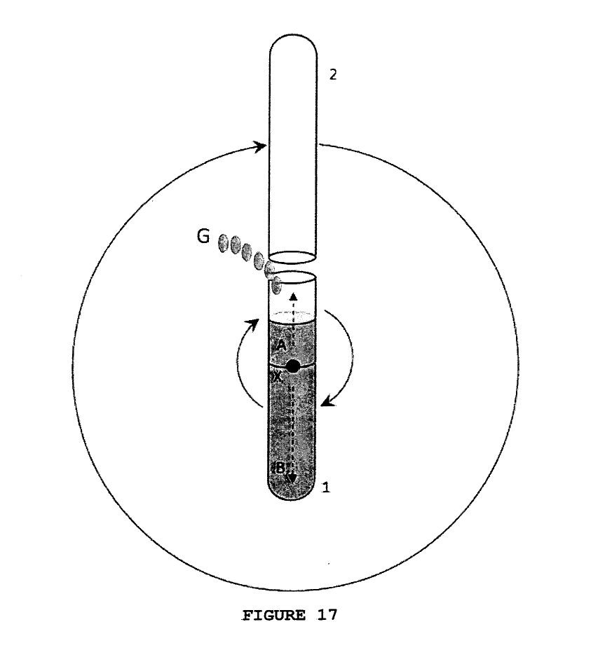

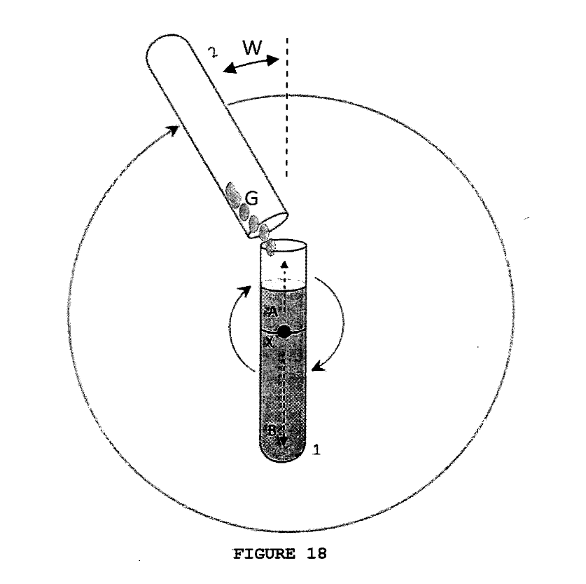

In most situations, the relative position of the destination tube (2) must be adjusted due to the existence of the Coriolis effect. This easier to demonstrate if one considers the liquid to be extracted transferring in drops to the destination container. These drops (G) follow the planned path for the acceleration of Coriolis. In a non-rotating frame of reference (inertial), the drops move in a straight line, away from the rotation axis. However, in the rotating frame of reference (non-inertial, the initial and destination tubes), the drops follow a curved, path (FIG. 17). The following example, in FIG. 18, shows an adjustment in the angle W which will depend on the speed and distance of the tube 2 to tube 1. The angle W is preferably in the range of 20 to 70 degrees. The actual angle can be easily calculated from the Coriolis acceleration force formula.

In a preferred embodiment the test tubes are of 13 mm (10-15 mm preferably) diameter tube with 75 mm height (50-100 mm preferably). In another preferred embodiment, the liquid transfer range is preferably between 50 uL to 3 mL. In yet another preferred embodiment, the precision range is preferably 25 to 50 uL but this mostly dependent on the tube diameter.

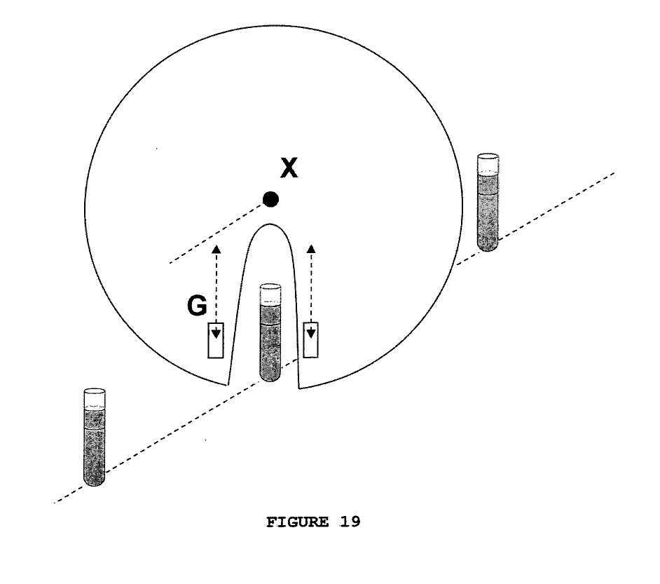

With the described disc model placed in an automation belt (FIG. 19), it is fairly easy to pick the tube with a grip (G) that may also adjust the distance to the rotation axis. The sample can then be manipulated and portions extracted onto secondary containers preferably placed onto a secondary belt (not shown).

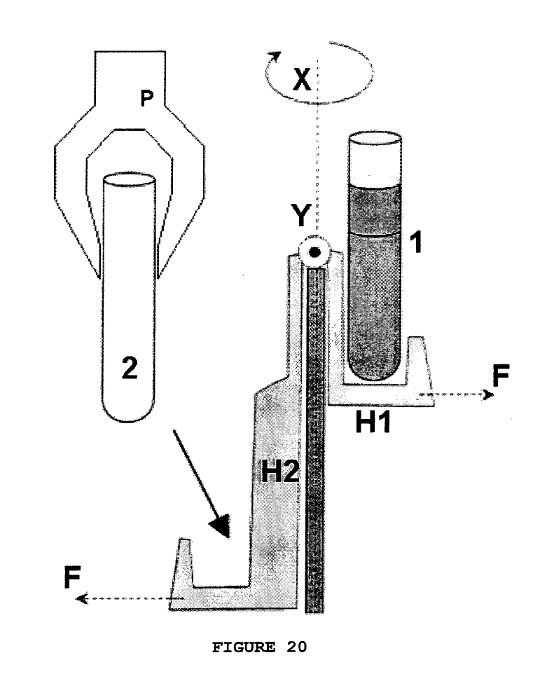

With a pick and place Robot, see FIG. 20, the Robot arm can place the primary and secondary tubes in one of the inclined embodiments, in particular the pendulum system already described.

In another embodiment, the robot can comprise the invention directly in its arm and simply picks up the tubes directly in their rotational locations, prior to the rotation for transfer of its contents.

The rotation of the device can be easily accomplished by electric motors for example. Stepper motors are preferential for enabling exact control of the position and high accelerations, both positive factors for achieving precise control Of the Centrifugal force and sample extraction while at the same time avoiding unnecessary spillage.

1. A centrifugal device for separating or transferring container contents comprising a rotation axis (x) suitable for applying a centrifugal force (F) to extract part (A) or whole (A, B) of the container (1) contents.

2. The device according to claim 1 for separating container contents, wherein the rotation axis (x) location is substantially aligned with the boundary of the content parts (A, B) to be separated.

3. The device according to claim 1, wherein the rotation axis location (x) is substantially aligned with the innermost part of the container (1) or further distanced from both the innermost part and opening part of the container (1).

4. The device according to claim 1 further comprising a holder (P) to place the container (1) at an angle (V), in respect of the axis of its opening part and the rotation axis (x).

5. The device according to claim 4 further comprising a holder (P) to place the secondary container (2) at an angle, in respect of the axis of its opening part and the rotation axis (x), with its opening substantially directed towards the opening of the first container (1).

6. The device according to claim 5, wherein the holders (P) to place the first container (1) and secondary container (2) are rigidly coupled.

7. The device according to claim 5, wherein the holders (H1, H2) to place the first container (1) and secondary container (2) are rotationally coupled (Y) substantially perpendicularly to the rotation axis (x).

8. The device according to claim 7, wherein the holders (H1, H2) to place the first container (1) and secondary container (2) are coupled (C) through one or two pulleys (K) fixed at the rotation axis (x).

9. The device according to claim 8, wherein the coupling (C) for the holders (H1, H2) for the first container (1) and secondary container (2) is the same complementary coupling to the same pulley (K).

10. The device according to claim 1 further comprising a holder (Disc1) to place the container (1) vertically and substantially perpendicular, in respect of the axis of its opening part and the rotation axis (x).

11. The device according to claim 10 further comprising a holder (Disc2) to place the secondary container (2) substantially parallel, in respect of the axis of its opening part and the rotation axis (x), with its opening substantially directed towards the opening of the first container (1).

12. The device according to claim 11, wherein the holder (Disc2) to place the secondary container (2) may be rotated relative to the holder (Disc1) for the first container (1), suitable for rotating both containers to substantially vertical positions when the device is static.

13. The device according to claim 1, wherein the holders (P) to place the first container (1) and secondary container (2) are at an angle (w), in respect of the axis of the opening part of the first container (1) and the axis of the opening part of the secondary container (2), suitable to compensate for the Coriolis effect affecting the extracted sample (G).

14. The device according to claim 1, wherein the container (1) or containers (1, 2) are laboratory test tubes.

15. The device according to claim 1, wherein the container contents (A, B) is a laboratory blood sample.

16. A laboratory automated system comprising the device according to claim 1.

17. The laboratory automated system according to claim 16, further comprising a transport belt or pick and place robot.

18. A method for the centrifugal separation or transferral of container contents comprising rotating a container (1), through a rotation axis (x) and sufficient speed, suitably for applying a centrifugal force (F) to extract part (A) or whole (A, B) of the container (1) contents.

19. The method according to claim 18 for the centrifugal separation of container contents, wherein the rotation axis (x) location is substantially aligned with the boundary of the content parts (A, B) to be separated.

20. The method according to claim 18, wherein the rotation axis location (x) is substantially aligned with the innermost part of the container (1) or further distanced from both the innermost part and opening part of the container (1).

21-24. (canceled)
